(19) United States
(12) Patent Application Publication
(10) Pub. No.: US 2007/0225479 A1
(43) Pub. Date: Sep. 27, 2007

(54) METHOD OF SEPARATING A POLYMER FROM A SOLVENT

(75) Inventors: Norberto Silvi, Clifton Park, NY (US); Mark Howard Giammattei, Selkirk, NY (US); Narayan Ramesh, Evansville, IN (US); Bernabe Quevedo Sanchez, Valladolid (ES)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/755,415

(22) Filed: May 30, 2007

Related U.S. Application Data
(63) Continuation-in-part of application No. 11/298,365, filed on Dec. 8, 2005.
Application No. 11/298,365 is a continuation-in-part of application No. 11/144,141, filed on Jun. 3, 2005, now Pat. No. 7,122,619.
Application No. 11/144,141 is a continuation of application No. 10/648,524, filed on Aug. 26, 2003, now Pat. No. 6,949,622.

(51) Int. Cl. C08J 3/00

(52) U.S. Cl. 528/501

(57) ABSTRACT

The present invention provides a method of separating a polymer from a solvent comprising introducing a superheated polymer-solvent mixture into an extruder, and isolating a polymer product, said extruder being equipped with at least one vent operated at subatmospheric pressure and at least one vent operated at about atmospheric pressure, said extruder having a screw diameter D, said extruder being operated at a feed rate FR and at a screw speed RPM such that a devolatilization performance ratio (DPR) given by Equation (I)
DPR=FR/RPM Equation (I) is selected from a predetermined set of devolatilization performance ratios which correlate with a target characteristic of the polymer product.

### CROSS REFERENCE TO RELATED APPLICATIONS

This application is a continuation-in-part of U.S. patent application Ser. No. 11/298,365, entitled “METHOD OF SEPARATING A POLYMER FROM A SOLVENT”, filed on Dec. 8, 2005, which is a continuation-in-part of U.S. patent application Ser. No. 11/144,141, now U.S. Pat. No. 7,122,619, filed on Jun. 3, 2005, which is a continuation of U.S. patent application Ser. No. 10/648,524, now U.S. Pat. No. 6,949,622 filed on Aug. 26, 2003.

### BACKGROUND

The invention relates generally to methods of producing polymer compositions. More particularly the invention relates to methods for separating a polymer composition from a solvent.

The preparation of polymer compositions is frequently carried out in a solvent. The polymer composition must be separated from the solvent prior to molding, storage or other such applications since the solvent will interfere in many cases with such processes. The bulk of the solvent may easily be removed by using processes commonly known to one skilled in the art. However, the challenge lies in reducing the solvent content in the polymer composition to parts per million levels. It is of interest therefore, to have a convenient and cost-effective method to isolate a polymer composition from a polymer-solvent mixture.

A further challenge resides in the general inability to predict and select operating conditions to be used when effecting solvent separation from a polymer-solvent mixture based upon limited test results generated using a particular piece of devolatilization equipment. The present invention provides, among other benefits, a simple and yet elegant solution to this problem.

### BRIEF DESCRIPTION

In one embodiment, the present invention provides a method of separating a polymer from a solvent, the method comprising introducing a superheated polymer-solvent mixture into an extruder, and isolating a polymer product, said extruder being equipped with at least one vent operated at subatmospheric pressure and at least one vent operated at about atmospheric pressure, said extruder having a screw diameter D, said extruder being operated at a feed rate FR and at a screw speed RPM such that a devolatilization performance ratio (DPR) given by Equation (I)
DPR=FR/(RPM) Equation (I)
is selected from a predetermined set of devolatilization performance ratios which correlate with a target characteristic of the polymer product.

In yet another embodiment, the present invention provides a method of separating a polyetherimide from a solvent comprising introducing a superheated polymer-solvent mixture comprising a polyetherimide and a solvent into an extruder, and isolating a polyetherimide product, said solvent comprising at least 25 percent by weight of the polymer-solvent mixture, said extruder being equipped with at least one vent operated at subatmospheric pressure and at least one vent operated at about atmospheric pressure, said extruder having a screw diameter D, said extruder being operated at a feed rate FR and at a screw speed RPM such that a devolatilization performance ratio (DPR) given by Equation (I)
DPR=FR/(RPM) Equation (I)
is selected from a predetermined set of devolatilization performance ratios which correlate with a characteristic of the polyetherimide product, wherein said characteristic of the polyetherimide product is a concentration of solvent of less than 20 parts per million.

In yet another embodiment, the present invention provides a method of separating a polymer from a solvent, said method comprising introducing a superheated polymer-solvent mixture into an extruder, and isolating a polymer product, said extruder being equipped with at least one vent operated at subatmospheric pressure and at least one vent operated at about atmospheric pressure, said extruder having a screw diameter D in a range from about 130 to about 380 millimeters, said extruder being operated at a feed rate FR and at a screw speed RPM such that a devolatilization performance ratio (DPR) given by Equation (I)
DPR=FR/(RPM) Equation (I)
is selected from a predetermined set of devolatilization performance ratios which correlate with a characteristic of the polymer product.

These and other features, aspects, and advantages of the present invention may be understood more readily by reference to the following detailed description.

### DRAWINGS

The following drawings are provided to allow those skilled in the art to better understand and practice the invention. In the accompanying drawings like characters represent like parts.

FIG. 1 illustrates a system comprising a devolatilizing extruder for separating a polymer-solvent mixture, the system being useful in the practice of the present invention.

FIG. 2 illustrates a system comprising a devolatilizing extruder for separating a polymer-solvent mixture, the system being useful in the practice of the present invention.

FIG. 3 illustrates a series of experiments carried out to correlate a ratio of feed rate to screw speed with a target characteristic of a polymer product being isolated from a solvent on a laboratory devolatilizing extruder.

FIG. 4 illustrates a series of experiments carried out to correlate a ratio of feed rate to screw speed with a target characteristic of a polymer product being isolated from a solvent on a pilot scale devolatilizing extruder.

### DETAILED DESCRIPTION

Some aspects of the present invention and general scientific principles used herein can be more clearly understood by referring to U.S. patent application Ser. No. 11/298,365 filed on Dec. 8, 2005; U.S. Pat. No. 7,122,619; and U.S. Pat. No. 6,949,622, which are incorporated by reference herein. It should be noted that with respect to the interpretation and meaning of terms in the present application, in the event of a conflict between this application and any document incorporated herein by reference, the conflict is to be resolved in favor of the definition or interpretation provided by the present application.

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein, the term “solvent” can refer to a single solvent or a mixture of solvents.

Approximating language, as used herein throughout the specification and claims, may be applied to modify any quantitative representation that could permissibly vary without resulting in a change in the basic function to which it is related. Accordingly, a value modified by a term or terms, such as “about”, are not to be limited to the precise value specified. In some instances, the approximating language may correspond to the precision of an instrument for measuring the value.

In one embodiment, the present invention employs a devolatilizing extruder having a screw diameter D, said extruder being operated at a feed rate FR and at a screw speed RPM such that a devolatilization performance ratio (DPR) given by Equation (I)
DPR=FR/(RPM) Equation (I)
is selected from a predetermined set of devolatilization performance ratios which correlate with a characteristic of the polymer product.

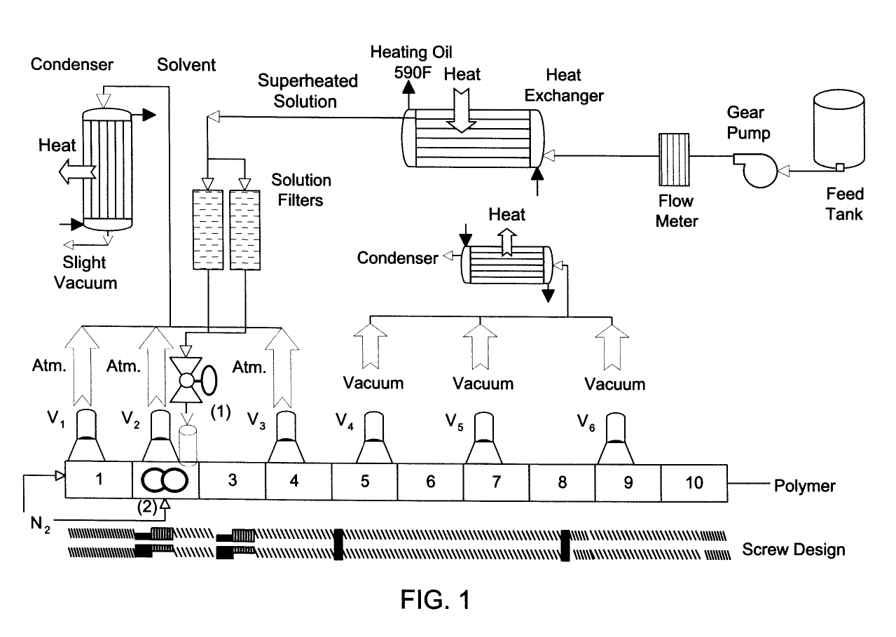

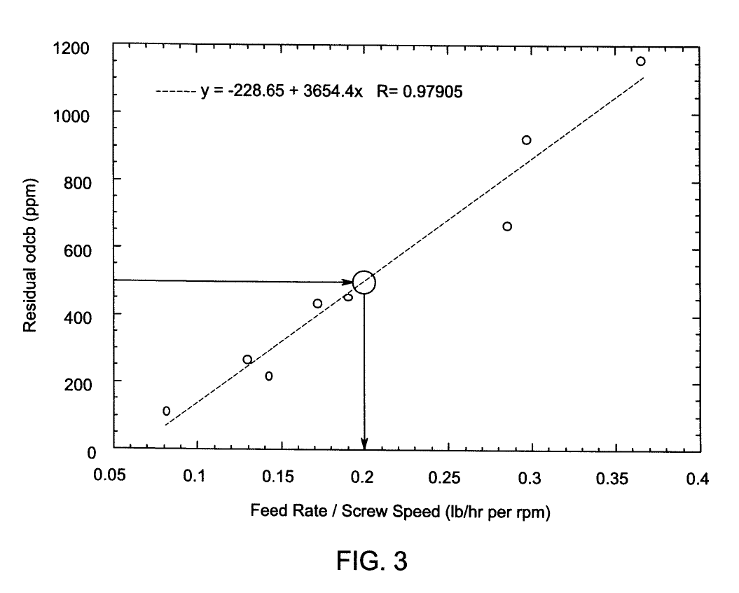

Thus, one aspect of the present invention involves the determination of a set of devolatilization performance ratios correlating with a target characteristic of the polymer product. The target characteristic may be a concentration of residual solvent, a concentration of residual monomers or by-products, a molecular weight of the polymer product, a percentage of co-polymer formation, or other measurable characteristic of the polymer product which is dependent upon the extrusion conditions employed. The process is illustrated as follows. First a polymer-solvent mixture is fed to a devolatilizing extruder, for example a laboratory scale devolatilizing extruder, and a series of experiments is carried out in which the feed rate and/or screw speed are varied to provide a set of polymer product characteristics which correlate with a set of devolatilization performance ratios. FIG. 3 illustrates such a series of experiments in which a polymer-solvent mixture containing 30 percent by weight polyetherimide polymer (ULTEM®) and 70 percent by weight orthodichlorobenzene (ODCB) is fed to a 25 mm laboratory scale extruder configured approximately as in FIG. 1). As shown in FIG. 3 the characteristic for the polymer product in this example is a residual concentration of orthodichorobenzene which varied from of about 113 parts per million (ppm) to about 1700 ppm. The data can be used to predict a devolatilization performance ratio to be used when (1) the target characteristic of the polymer product falls outside of the range covered by the experimental data, or (2) the target characteristic of the polymer product is simply different from any of the experimentally determined devolatilization performance ratios. For example the data which are plotted in FIG. 3 and are tabulated in Tables 1 and 2 allow one to calculate a devolatilization performance ratio which will provide that a target characteristic of the polymer product of 20 ppm residual ODCB may be achieved at a devolatilization performance ratio of about 0.068 (target characteristic of the polymer product outside of range of experimental data). The data also show that at a devolatilization performance ratio of about 0.20 pounds of polymer-solvent mixture per hour per revolutions per minute a target characteristic for the polymer product of 500 ppm ODCB may be achieved (target characteristic of the polymer product different from any of the experimentally determined values).

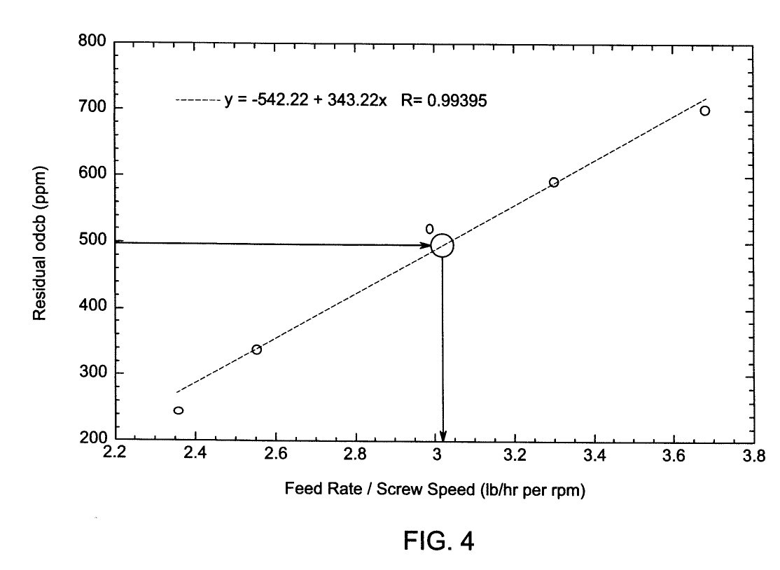

FIG. 4 illustrates a similar series of experiments carried out on a pilot scale. The data plotted in FIG. 4, are given in Table 5 and is discussed in the Experimental Section of this disclosure.

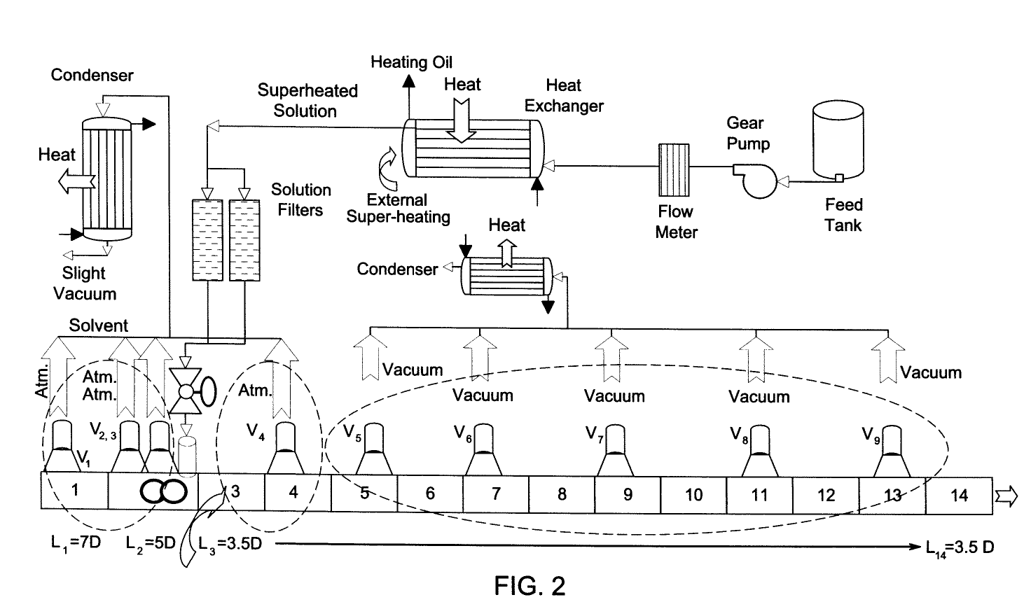

As noted, in one embodiment, the method of the present invention employs a devolatilizing extruder, to separate a polymer-solvent mixture and provide a polymer product. The extruder is equipped with at least one vent operated at subatmospheric pressure and at least one vent operated at about atmospheric pressure. FIG. 1 illustrates a laboratory scale devolatilizing extruder and associated attachments (feed tank, heat exchangers, filters, vacuum manifold, condensers, feed inlet valve, and like attachments) which may be used in the practice of the present invention. FIG. 1 features a 10-barrel, twin screw extruder comprising a plurality of vents designed to operate at about atmospheric pressure and a plurality of vents designed to operate at subatmospheric pressure. FIG. 2 illustrates a pilot scale devolatilizing extruder and associated attachments (feed tank, heat exchangers, filters, vacuum manifold, condensers, feed inlet valve, and like attachments) which may be used in the practice of the present invention. FIG. 2 features a 14-barrel, twin-screw extruder comprising a plurality vents designed to operate at about atmospheric pressure and a plurality vents designed to operate at subatmospheric pressure.

The polymer-solvent mixture may comprise one or more polymers dissolved or dispersed in one or more solvents, such as for example a mixture of polyetherimide in orthodichlorobenzene (ODCB), a mixture of polyetherimide and polyphenylene ether in ODCB, or a mixture of polysulfone in ODCB and methane sulfonic acid. In certain embodiments, the polymer-solvent mixture may further include a filler and/or one or more additives. Other solvents which may be used in the polymer-solvent mixture include toluene, xylene, anisole, veratrole, methylene chloride, and combinations thereof.

In one embodiment, the polymer-solvent mixture is heated under pressure to produce a superheated polymer-solvent mixture, wherein the temperature of the superheated mixture is greater than the boiling point of the solvent at atmospheric pressure. In one embodiment, the temperature of the superheated polymer-solvent mixture may be about 2° C. to about 200° C. higher than the boiling point of the solvent at atmospheric pressure. In one embodiment, the temperature of the superheated polymer-solvent mixture is less than or equal to about 150° C. In another embodiment, the temperature of the superheated polymer-solvent mixture is less than or equal to about 100° C.

As noted, the polymer-solvent mixture may comprise multiple solvents. When there are multiple solvents present, the polymer-solvent mixture is superheated with respect to at least one of the solvent components. In certain embodiments, the polymer-solvent mixture may contain significant amounts of both high boiling and low boiling solvents. In such an event, it may be sometimes advantageous to superheat the polymer-solvent mixture with respect to all solvents present (i.e., above the boiling point at atmospheric pressure of the highest boiling solvent). In one embodiment, superheating of the polymer-solvent mixture may be achieved by heating the polymer-solvent mixture under pressure.

In the present application, the term “superheated” refers to the phenomenon in which a liquid is heated to a temperature higher than its standard boiling point, without actually boiling. A superheated polymer-solvent mixture can be prepared by heating a polymer-solvent mixture to a temperature above the boiling point of the solvent present in the polymer-solvent mixture at a pressure sufficient to prevent boiling of the solvent. Superheated polymer-solvent mixtures are conveniently prepared by heating a polymer-solvent mixture in a pressurized vessel to a temperature above the normal boiling point of the solvent at a pressure greater than 1 atmosphere.

The polymer-solvent mixture may be superheated by employing a heat exchanger or multiple heat exchangers in a manner known to one skilled in the art. Pumps, such as for example, gear pumps may be used to transfer the super-heated polymer-solvent mixture through one or more heat exchangers.

When the polymer-solvent mixture is pressurized, the system employed to deliver the superheated polymer-solvent mixture to the devolatilizing extruder may comprise a pressure control valve as the feed inlet valve, downstream of the heat exchanger used to superheat the polymer-solvent mixture. Heat exchangers for superheating the polymer-solvent mixture are shown in each of FIG. 1 and FIG. 2. The pressure control valve (shown in FIG. 1 and FIG. 2 is located immediately below the solution filters and is connected to the extruder at barrel 2) preferably has a cracking pressure higher than atmospheric pressure. The cracking pressure of the pressure control valve may be set electronically or manually and is typically maintained at from about 1 pound per square inch (psi) (0.07 kgf/cm²) to about 350 psi above atmospheric pressure. Within this range, the cracking pressure employed may be less than or equal to about 200 psi, or more specifically may be less than or equal to about 150 psi above atmospheric pressure. Also within this range the cracking pressure may be greater than or equal to about 5 psi, or more specifically greater than or equal to about 10 psi above atmospheric pressure. The back pressure generated by the pressure control valve is typically controlled by increasing or decreasing the cross sectional area of the valve opening. Typically, the degree to which the valve is open is expressed as percent (%) open, meaning the cross sectional area of valve opening actually being used relative to the cross sectional area of the valve when fully opened. The pressure control valve prevents evaporation of the solvent as it is heated above its boiling point. In one embodiment, the pressure control valve is attached directly to an extruder and serves as the feed inlet of the extruder. A suitable exemplary pressure control valve includes a RESEARCH® Control Valve, manufactured by BadgerMeter, Inc. Spring loaded pressure control valves may be used advantageously as well.

Generally, the feed inlet through which the polymer-solvent mixture is fed to the feed zone of the extruder may be in close proximity to a nearby vent. In one embodiment, the extruder comprises a vent operated at about atmospheric pressure said vent being located upstream of the feed inlet, which is used to effect the bulk of the solvent removal. Such a vent, being located upstream of the extruder feed inlet is at times herein described as an upstream vent. The extruder may be equipped with a vent operated at about atmospheric pressure located downstream of the feed inlet of the extruder. Typically, the extruder comprises multiple vents being operated at about atmospheric pressure, said vents being located upstream of the extruder feed inlet, downstream of the extruder feed inlet, adjacent to the extruder feed inlet, or in a combination of the foregoing locations. In one embodiment, at least one of the vents is operated at subatmospheric pressure. Typically the extruder, the feed inlet, and an upstream vent are configured to provide the volume needed to permit an efficient flash evaporation of the solvent from the polymer-solvent mixture thus playing a major role in bulk devolatilization of the solvent. Downstream vents (e.g. vents V₄, V₅, and V₆ shown in FIG. 1) may play an important role in the trace devolatilization of the solvent to provide a polymer product composition having a residual solvent concentration characteristic. The polymer product may contain a significant amount of solvent, for example 1000 parts per million (ppm) solvent, or contain only minute amounts of solvent, for example less than 20 ppm of solvent.

In one embodiment, a particular solvent concentration in the product polymer is referred to a target characteristic of the polymer product. As is shown herein, in one embodiment, the present invention provides a method of removing solvent from a polymer-solvent mixture using a devolatilizing extruder operated according to predetermined devolatilization performance ratio (DPR) which correlates with the target characteristic of the polymer product, for example a residual solvent concentration of 20 ppm solvent. Upon reading the instant application, those skilled in the art will recognize that an important advantage provided by the present invention is that once a limited set of experiments has been conducted and a set of devolatilization performance ratios has been determined, a devolatilization performance ratio (DPR) which correlates with a target characteristic of the polymer product may be identified for an extruder even though the target characteristic of the polymer product falls outside of the experimentally determined range without additional experimentation. For example, a limited set of devolatilization performance ratios may be determined on a large-scale commercial devolatilizing extruder and correlated with a set of target product polymer characteristics. The data may then be used to predict a devolatilization performance ratio which correlates with a target characteristic of the polymer product without additional experimentation. Thus, in one embodiment, the present invention obviates the need to conduct the extensive experimentation on a commercial scale devolatilizing extruder usually necessary to achieve a target characteristic of the polymer product, as a given process is transitioned from laboratory and pilot scale experimentation to commercial scale production.

In one embodiment, the method of the present invention employs an extruder comprising a side feeder equipped with a side feeder vent. A side feeder equipped with a vent provides a means for removal of the rapidly evaporating solvent while at the same time providing a means for trapping and returning polymer particles entrained by the escaping solvent vapors. In one embodiment, the extruder in combination with the side feeder is equipped with one or more vents in close proximity to the extruder feed inlet. The side feeder is typically positioned in close proximity to the feed inlet through which the polymer-solvent mixture is introduced into the extruder. In one embodiment, the side feeder is located upstream from the feed inlet. FIG. 1 illustrates an extruder comprising a side feeder (indicated by a pair of connected circles on barrel 2 of the extruder) located between upstream vent V₁ and downstream vent V₃ and in close proximity to the feed inlet. FIG. 2 illustrates an extruder comprising two side feeders (indicated by a pair of connected circles on barrel 2 of the extruder) located between upstream vent V₁ and downstream vent V₄ in close proximity to the feed inlet. In FIG. 1 vent V₂ is located on the side feeder. In FIG. 2 vents V₂ and V₃ are located on a first and second side feeder respectively. In one embodiment, the side feeder comprises a vent operated at about atmospheric pressure. In another embodiment, the side feeder comprises a vent operated at subatmospheric pressure. In another embodiment, the side feeder comprises a feed inlet, in which instance the side feeder feed inlet is attached to the side feeder at a position between the point of attachment of the side feeder to the extruder and the side feeder vent. In yet another embodiment, the polymer-solvent mixture may be introduced through feed inlets which may be attached to the side feeder, the extruder, or to both extruder and side feeder.

Suitable configurations of the side feeder include configurations in which the side feeder has a length to diameter ratio (L/D) of less than or equal to about 20. In certain instances the devolatilizing extruder comprises one or more side feeders having a length to diameter ratio of less than or equal to about 12. The side feeder is typically not heated and functions to provide additional cross sectional area within the feed zone of the extruder thereby allowing higher throughput of the polymer-solvent mixture. Suitable types of side feeders include single-screw side feeders and twin-screw side feeders. In one embodiment, the side feeder used is of the twin-screw type. The screw elements of the side feeder are configured to convey the polymer (which is deposited in the side feeder as the solvent rapidly evaporates) back to the main channel of the extruder. Typically, the side feeder is equipped with at least one vent located near the end of the side feeder most distant from the point of attachment of the side feeder to the extruder. The side feeder may be heated to prevent condensation of a some or all of the solvent.

As noted, the side feeder screw elements are typically conveying elements which serve to transport polymer deposited within the side feeder by escaping solvent back into the main channel of the extruder. In one embodiment, the side feeder screw elements comprise kneading elements, in addition to conveying elements. Side feeders comprising kneading elements are especially useful in instances in which the evaporating solvent has a tendency to entrain polymer particles in a direction opposite that provided by the conveying action of the side feeder screw elements and out through the vent of the side feeder. The screw or screws employed within the main channel of the devolatilizing extruder may comprise various combinations of conveying elements, kneading elements and the like. In certain embodiments the extruder screw(s) comprise one or more kneading elements between the point of introduction of the polymer-solvent mixture (the feed inlet) and one or more of the upstream vents. The kneading elements may in certain instances improve overall performance by acting as mechanical filters to intercept polymer particles being entrained by the solvent vapor moving toward the vents.

The extruder used in the practice of the invention may comprise any number of barrels, type of screw elements, etc. as long as it is configured to provide sufficient volume for the rapid evaporation of the solvent through vents operated at or near atmospheric pressure, and effect further removal of remaining solvent through vents operated at subatmospheric pressure, such that the target characteristic of the polymer product is achieved. Exemplary extruders suitable for use in the practice of the present invention include twin-screw counter-rotating extruders, twin-screw co-rotating extruders, single-screw extruders, and single-screw reciprocating extruders. In one embodiment, the extruder is a co-rotating, intermeshing (i.e. self wiping) twin-screw extruder.

In general, as the feed rate of the polymer-solvent mixture is increased a corresponding increase in the screw speed must be made in order to accommodate the additional material being fed to the extruder if flooding of the upstream portion of the extruder is to be avoided. Moreover, the screw speed determines in part the residence time of the material being fed to the extruder. Thus, the screw speed and feed rate are typically interdependent. It is useful to characterize this relationship between feed rate and screw speed as a ratio. This ratio forms an important element in determining the devolatilization performance ratio (DPR), discussed herein. The maximum and minimum feed rates and extruder screw speeds are determined by, among other factors, the size of the extruder, the general rule being the larger the extruder the higher the maximum and minimum feed rates.

In one embodiment, the polymer-solvent mixture may be fed into a vented extruder (also referred to herein as a devolatilizing extruder) to effect the removal of the solvent from the polymer-solvent mixture. The extruder can be configured to have sufficient volume to permit efficient flash evaporation of solvent from the polymer-solvent mixture, even in the case of very dilute polymer-mixtures, for example a polymer-solvent mixture comprising less than about 5 percent by weight polymer and more than about 95 percent by weight solvent.

In one embodiment, the predetermined set of devolatilization performance ratios is determined using experimental data from a devolatilizing extruder. In one embodiment, the extruder has a screw diameter D, and the extruder is operated at a feed rate FR and at a screw speed RPM to provide a polymer product having a target characteristic. The devolatilization performance ratio (DPR) is given by Equation (I).
DPR=FR/(RPM) Equation (I)

The optimum value of the devolatilization performance ratio DPR corresponds to the maximum rate at which the polymer-solvent mixture may be introduced into the extruder and still attain the target characteristic of the polymer product. In one embodiment, the target characteristic of the polymer product is a residual solvent concentration of less than about 20 ppm.

In one embodiment, the extruder screw diameter D is in a range from about 10 millimeters to about 30 millimeters, the polymer product is a polyetherimide, the target characteristic of the polymer product is a concentration of residual orthodichlorobenzene solvent. In another embodiment, D is in a range from about 30 millimeters to about 60 millimeters. In yet another embodiment, D is in a range from about 60 millimeters to about 140 millimeters. In yet another embodiment, D is in a range from about 140 millimeters to about 380 millimeters.

In one embodiment, the extruder employed to generate a predetermined set of devolatilization performance ratios is a 25 millimeter diameter, twin-screw, 10-barrel, vented extruder having a length to diameter (L/D) ratio of 40.

In one embodiment, the pilot scale extruder employed to generate a predetermined set of devolatilization performance ratios is a 58 millimeter diameter, twin-screw, 14-barrel, vented extruder having a length to diameter ratio of 54.

The polymer-solvent mixture may comprise a wide variety of polymers. Exemplary polymers include polyetherimides, polycarbonates, polycarbonate esters, poly(arylene ether)s, polyamides, polyarylates, polyesters, polysulfones, polyetherketones, polyimides, olefin polymers, polysiloxanes, poly(alkenyl aromatic)s, and blends comprising at least one of the foregoing polymers. In instances where two or more polymers are present in the polymer-solvent mixture, the polymer product may be a polymer blend, such as a blend of a polyetherimide and a poly(arylene ether) or a blend of polyetherimide and a polycarbonate ester. It is advantageous to pre-disperse or pre-dissolve the two or more polymers within the polymer-solvent mixture. This allows for the efficient and uniform distribution of the polymers in the resulting isolated polymer product matrix.

As used herein, the terms polymer and polymer product refer to both high and low molecular weight polymers. A high molecular weight polymer has a number average molecular weight Mₙ of at least 10,000 grams per mole as measured using gel permeation chromatography. A low molecular weight polymer has a number average molecular weight Mₙ of less than 10,000 grams per mole as measured using gel permeation chromatography. Low molecular weight polymers include oligomeric materials, for example an oligomeric polyetherimide having a number average molecular weight of about 800 grams per mole as measured by gel permeation chromatography.

In one embodiment, the polymer-solvent mixture comprises a polyetherimide comprising structural units having structure I 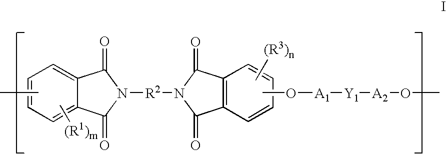
wherein R¹ and R³ are independently at each occurrence halogen, C₁-C₂₀ alkyl, C₆-C₂₀ aryl, C₇-C₂₁aralkyl, or C₅-C₂₀ cycloalkyl; R² is C₂-C₂₀ alkylene, C₄-C₂₀ arylene, C₅-C₂₀ aralkylene, or C₅-C₂₀ cycloalkylene; A¹ and A² are each independently a monocyclic divalent aryl radical, Y¹ is a bridging radical in which one or two carbon atoms separate A¹ and A²; and m and n are independently integers from 0 to 3.

Polyetherimides having structure I include polymers prepared by condensation of bisphenol-A dianhydride (BPADA) with an aromatic diamine such as m-phenylenediamine; p-phenylene diamine; bis(4-aminophenyl)methane; bis(4-aminophenyl)ether; hexamethylenediamine; 1,4-cyclohexanediamine; and the like.

In one embodiment, the methods described herein are particularly well suited to the separation of polymer-solvent mixtures comprising one or more polyetherimides comprising structural units having structure I. The physical properties, such as color and impact strength, of polyetherimide may be sensitive to impurities introduced during manufacture or handling, and the effect of such impurities may be aggravated during solvent removal. One aspect of the polymer solvent separation method discussed herein demonstrates its applicability to the isolation of polyetherimides prepared via distinctly different chemical processes.

Polymer products isolated according to the methods described herein may be transformed into useful articles directly, or may be blended with one or more additional polymers or polymer additives and subjected to injection molding, compression molding, extrusion methods, solution casting methods, and like techniques to provide useful articles.

### EXAMPLES

The following examples are set forth to provide those of ordinary skill in the art with a detailed description of how the methods claimed herein are carried out and evaluated, and are not intended to limit the scope of what the inventors regard as their invention. Unless indicated otherwise, parts are by weight and temperature is in degrees centigrade (° C.).

Molecular weights are reported as number average (Mₙ) or weight average (M_{w}) molecular weight and were determined by gel permeation chromatography (GPC) using polystyrene (PS) molecular weight standards.

### Examples 1-9 Determination of Devolatilization Performance Ratios Correlating with Residual Solvent Concentration for a Laboratory Scale Devolatilizing Extruder

A polymer-solvent mixture containing about 30 percent by weight polyetherimide (ULTEM® 1010 polyetherimide; prepared by the nitro-displacement process; commercially available from GE Plastics, MT Vernon, Ind.) and about 70 percent by weight ODCB was prepared and heated to a temperature of 150 to 160° C. in a feed tank under a nitrogen atmosphere at a pressure of about 100 psi. Approximately 180 pounds of the polymer-solvent mixture was fed to the extruder over the course of nine experiments constituting Examples 1-9 shown in Table 1 which were carried out over a two and a half hour period without interruption.

The devolatilizing extruder and associated attachments employed was analogous to that shown schematically in FIG. 1. The polymer-solvent mixture was fed continuously from a heated feed tank by means of a gear pump via a flow meter into a heat exchanger where the polymer-solvent mixture was superheated. The extruder employed was a 25 mm diameter, co-rotating, intermeshing twin-screw extruder comprising 10 barrels (L/D=40) and 5 vents for removal of volatile components. The screw design comprised standard conveying elements under the feed inlet and under all vents. A left handed kneading block (LHKB) was positioned in barrel 6 upstream of the vacuum vents on barrels 7 and 9 to provide a melt seal. Right handed kneading blocks (RHKB) and one neutral kneading block (NKB) were positioned in barrels 3 and 4. Six right handed kneading blocks were positioned downstream of the melt seal to enhance surface area renewal. A complete listing of the screw elements employed is given in the Table of screw elements which follows. Atmospheric vents were located on barrels 1, 2, and 5 and were operated at slightly reduced pressure, nominally 742 to 745 torr using a Venturi device to create a slight vacuum. Vents operated at substantially subatmosphereic pressure were located on barrels 7 and 9. The atmospheric vent at barrel 5 had a Type C insert. Vents at barrels 1, 2, 7 and 9 had no inserts. The extruder barrel temperature was set to about 371° C. in the upstream (flash evaporation section) portion of the extruder, and 343° C. in the downstream vacuum vented portion of the extruder. The feed port was located at the downstream edge of barrel 2.

Table of Screw Elements Employed In Examples 1-9

| Element | |
|---|---|
| Order | W&P Code* |
| 1 | 24/24 |
| 2 | 36/36 |
| 3 | 24/24 |
| 4 | KB45/5/12 |
| | (6) |
| 5 | 36/36 (2) |
| 6 | 24/24 |
| 7 | KB45/5/36 |
| 8 | KB45/5/12 |
| | (2) |
| 9 | KB45/5/24 |
| 10 | KB45/5/12 |
| | (2) |
| 11 | KB45/5/24 |
| 12 | KB90/5/24 |
| 13 | 36/36 (3) |
| 14 | 24/24 |
| 15 | 16/16 |
| 16 | KB45/5/12 |
| | LH |
| 17 | 24/24 |
| 18 | KB45/5/12 |
| 19 | 36/36 (2) |
| 20 | KB45/5/12 |
| 21 | 36/18 |
| 22 | KB45/5/12 |
| 23 | 36/18 |
| 24 | KB45/5/12 |
| 25 | 36/18 |
| 26 | KB45/5/12 |
| 27 | 36/18 |
| 28 | KB45/5/12 |
| 29 | 36/36 (4) |
| 30 | 24/24 |
| 31 | 24/12 (2) |
| 32 | 24/24 |

*Werner and Pfleiderer designation

The feed system including feed tank, transfer lines, gear pump, heat exchanger, solution filters and feed inlet valve, was flushed with ODCB before staring the series of experiments constituting Examples 1-9. The product polymer melt was extruded through a 2-hole die plate and pelletized. Representative pellets were analyzed for ODCB content by gas chromatography (GC). Table 2 presents the devolatilization performance ratio (FR/RPM) for each example together with the concentration of residual ODCB in the product polymer determined for each experiment. FIG. 3 plots the devolatilization performance ratio (FR/RPM) versus residual ODCB data obtained in Examples 1-8, the data from Example 9 being considered an outlier. From the data plotted in FIG. 3 a mathematical relationship
y=−228.65+3654.4x

wherein “y” is the concentration of residual ODCB solvent and “x” is the corresponding devolatilization performance ratio (FR/RPM) can be determined. Thus, residual solvent concentration in the polymer product may be predicted for a given devolatilization performance ratio. Alternatively, given a target residual solvent concentration in the polymer product, the relationship can be used to identify the appropriate devolatilization performance ratio to be used. Thus, if the target characteristic of the polymer product is a residual solvent concentration of 500 ppm (y=500) the devolatilization performance ratio (FR/RPM) should be about 0.20 pounds of polymer-solvent mixture per hour per revolutions per minute. If the target characteristic of the polymer product is a residual solvent concentration of 20 ppm (y=20) the devolatilization performance ratio (FR/RPM) should be about 0.068 pounds polymer-solvent mixture per hour per revolutions per minute. By way of further example, when the target characteristic of the polymer product is a residual solvent concentration of 500 ppm or less (y=500 or less) the devolatilization performance ratio (FR/RPM) should be about 0.20 pounds per hour per revolutions per minute or less. It should be noted that experimentally determined devolatilization performance ratios represent conditions which, for the particular devolatilizing extruder being used, correspond to a particular residual solvent concentration while operating the extruder at the maximum throughput rate for a give screw speed. The devolatilization performance ratios which can be calculated from the relationship established using the experimentally determined devolatilization performance ratios, together with the experimentally determined devolatilization performance ratios themselves, constitute a predetermined set of devolatilization performance ratios. Calculated values of the devolatilization performance ratio are gathered in Table 3. Calculated values of the devolatilization performance ratio are at times referred to herein as “predicted devolatilization performance ratios”, or as “predicted values of the devolatilization performance ratio”. The experimental data given in Table 2 show that for a given polymer-solvent mixture, extruder configuration and set of processing conditions, residual ODCB levels in a range of from about 100 ppm to about 1200 are observed when the ratio of polymer-solvent mixture feed rate in pounds per hour (FR) to screw speed in rpm (RPM) is varied between about 0.08 and about 0.36. As shown in FIG. 1, the data reveals an linear relationship between residual ODCB levels and the devolatilization performance ratio (FR/RPM).

TABLE 1
Experiments On A Laboratory Scale Devolatilizing Extruder Having Diameter D = 25 mm

| | Pressure at vents | | | | | | | | | | |
|---|---|---|---|---|---|---|---|---|---|---|---|
| | (mm Hg) | | | | | Solution | | Melt | Screw | Die | |
| | V1 | V2 | V4 | V5 | V6 | Mass Flow | Torque | Temp. | speed | Pressure | Actual Barrel Temperatures |
| Example | (B1) | (B2) | (B5) | (B7) | (B9) | Rate (lb/hr) | (%) | (° C.) | (rpm) | (psi) | (° C.) |
| 1 | 742 | 742 | 742 | 9.4 | 9.4 | 57 | 51 | 399 | 400 | 30 | 372 × 2/370 × 2/343/340/335/343 |
| 2 | 742 | 742 | 742 | 9 | 9 | 57 | 51 | 384 | 200 | 27 | 372/371/370/368/342/337/340/342 |
| 3 | 742 | 742 | 742 | 9 | 9 | 57 | 44 | 413 | 700 | TLTM | 371/372/377/379/346/352/355/346 |
| 4 | 742 | 742 | 742 | 9 | 9 | 73 | 53 | 404 | 385 | 33 | 371/372/371/370/343/341/338/342 |
| 5 | 743 | 743 | 743 | 9 | 9 | 73 | 53 | 386 | 200 | 20 | 372/370/371/367/341/337/334/342 |
| 6 | 744 | 744 | 744 | 10 | 10 | 97 | 54 | 407 | 327 | TLTM | 370 × 2/368/366/342/344/343/344 |
| 7 | 744 | 744 | 744 | 9.8 | 9.8 | 97 | 50 | 429 | 750 | 30 | 371 × 2/372/377/346/352/354/345 |
| 8 | 745 | 745 | 745 | 10 | 10 | 120 | 53 | 434 | 700 | 27 | 371/369/365/368/343/354/349/343 |
| 9 | 745 | 745 | 745 | 10 | 10 | 120 | 53 | 416 | 400 | 31 | 371/373/372/359/340/340/338/341 |

| | T feed @ | | T feed | | P @ | |
|---|---|---|---|---|---|---|
| | Feed | T feed after | before | P @ Heat | Flash | Residual |
| | Tank | Heat | P-valve | Exchanger | valve | odcb |
| Example | (° C.) | Exchanger (° C.) | (° C.) | (psi) | (psi) | (ppm) |
| 1 | 162 | 255 | 296 | 155 | 153 | 218 |
| 2 | 161 | 255 | 299 | 162 | 158 | 668 |
| 3 | 162 | 257 | 299 | 157 | 154 | 113 |
| 4 | 162 | 253 | 300 | 168 | 164 | 453 |
| 5 | 149 | 251 | 300 | 162 | 158 | 1160 |
| 6 | 151 | 239 | 300 | 170 | 165 | 926 |
| 7 | 149 | 239 | 302 | 171 | 166 | 267 |
| 8 | 154 | 232 | 302 | 180 | 173 | 435 |
| 9 | 157 | 233 | 302 | 184 | 178 | 1700 |

TABLE 2
Experimentally Determined Devolatilization Performance Ratios From
Laboratory Scale Devolatilizing Extruder Having Diameter D = 25 mm

| | Solution Mass Flow | Screw speed | Residual ODCB | |
|---|---|---|---|---|
| Example | Rate (lb/hr) | (rpm) | by GC (ppm) | DPR^{†} |
| 1 | 57 | 400 | 218 | 0.143 |
| 2 | 57 | 200 | 668 | 0.285 |
| 3 | 57 | 700 | 113 | 0.081 |
| 4 | 73 | 385 | 453 | 0.190 |
| 5 | 73 | 200 | 1160 | 0.365 |
| 6 | 97 | 327 | 926 | 0.297 |
| 7 | 97 | 750 | 267 | 0.129 |
| 8 | 120 | 700 | 435 | 0.171 |
| 9 | 120 | 400 | 1700 | 0.300 |

^{†}DPR = FR/RPM

TABLE 3
Predicted Devolatilization Performance Ratios For The Laboratory
Scale Devolatilizing Extruder Having Diameter D = 25 mm

| Target characteristic of | |
|---|---|
| the polymer product | Calculated DPR^{†} |
| 100 ppm ODCB | 0.090 |
| 80 ppm ODCB | 0.084 |
| 60 ppm ODCB | 0.079 |
| 40 ppm ODCB | 0.074 |
| 20 ppm ODCB | 0.068 |

^{†}Calculated DPR = (Target concentration of ODCB + 228.65)/3654.4

### Examples 10-14 Determination of Devolatilization Performance Ratios Correlating with Residual Solvent Concentration for a Pilot Scale Devolatilizing Extruder

A polymer-solvent mixture containing about 33.1 percent by weight polyetherimide (ULTEM® 1010 polyetherimide; prepared by the nitro-displacement process: commercially available from GE Plastics, MT Vernon, Ind.) and about 66.9 percent by weight ODCB was prepared and heated to a temperature of 150 to 160° C. in a feed tank under a nitrogen atmosphere. The system used to introduce the polymer-solvent mixture as a superheated solution was analogous to that used in Examples 1-9. The polymer-solvent mixture was fed to the pilot scale extruder over the course of five experiments constituting Examples 10-14 in Table 4 at a feed rate in rates a range from about 370 to about 950 pounds per hour of the polymer-solvent mixture. The pilot scale devolatilizing extruder and associated attachments employed was analogous to that shown schematically in FIG. 2. The pilot scale extruder employed was a 58 mm diameter, co-rotating, intermeshing twin-screw extruder comprising 14 barrels (L/D=54) and 8 vents (4 vacuum vents and 4 atmospheric vents) for removal of volatile components. The vacuum vents were maintained at two levels of vacuum, the vacuum vent closest to the feed inlet being maintained at moderate vacuum and the three downstream vacuum vents being maintained at high vacuum (˜10 torr). The screw design employed was analogous to that employed in the laboratory scale extruder used in Examples 1-9. Vents operated at substantially subatmosphereic pressure were located on barrels 7, 9, 11, and 13. The extruder barrel temperature was set to about 371° C. in the upstream (flash evaporation section) portion of the extruder, and 343° C. in the downstream vacuum vented portion of the extruder. The feed port was located at the downstream edge of barrel 2. Conditions employed are given Table 4.

The product polymer melt was pelletized and representative pellets were analyzed for ODCB content by gas chromatography (GC). Table 5 presents the feed rate/screw speed ratio for each example together with the concentration of residual ODCB in the product polymer pellets. FIG. 4 plots the FR/RPM versus residual ODCB data obtained in Examples 10-14. From the data plotted in FIG. 4 it can be determined, that in order to achieve a residual ODCB solvent concentration of 500 ppm (y=500) as the target characteristic of the polymer product the Feed Rate divided by the Screw Speed should be about 3.04 pounds of polymer-solvent mixture per hour per rpm.

TABLE 4
Experiments On A Pilot Scale Devolatilizing Extruder Having
Diameter D = 58 mm

| | | Screw | Medium | High | | Specific | | |
|---|---|---|---|---|---|---|---|---|
| | Mass flow | speed | vacuum | vacuum | Torque | energy | Melt Temp. | oDCB |
| Example | (lb/h) | (rpm) | (torr) | (torr) | (A) | (kJ/kg) | (° C.) | (ppm) |
| 10 | 368 | 100 | 28.3 | 9.7 | 130 | 688 | 372.8 | 703 |
| 11 | 660 | 200 | 40.0 | 9.5 | 143 | 910 | 392.8 | 594 |
| 12 | 942 | 400 | 55.4 | 6.6 | 137 | 1181 | 428.9 | 245 |
| 13 | 900 | 300 | 40.6 | 7.7 | 131 | 855 | 412.8 | 517 |
| 14 | 893 | 350 | 48.1 | 7.5 | 142 | 1163 | 422.8 | 339 |

TABLE 5
Results From Devolatilization Experiments On A Pilot Scale Extruder
Having Diameter D = 58 mm

| | | DEVOLATTLIZATION |
|---|---|---|
| | Residual ODCB | PERFORMANCE RATIO |
| Example | by GC (ppm) | (FR/RPM) |
| 10 | 703 | 3.680 |
| 11 | 594 | 3.300 |
| 12 | 245 | 2.355 |
| 13 | 517 | 3.000 |
| 14 | 339 | 2.551 |

The data from Examples 10-14 which is plotted in FIG. 4 yields the following mathematical relationship
y=−542.22+343.22x

wherein “y” is the concentration of residual ODCB solvent, and “x” is the corresponding devolatilization performance ratio (FR/RPM). As in the case of the laboratory scale devolatilizing extruder experiments, this relationship can be used to predict devolatilization performance ratios corresponding to target solvent concentrations falling outside of the range encompassed by the experimental data. As in the case of the laboratory scale experiments, the experimentally determined pilot scale devolatilization performance ratios represent conditions which, for the particular pilot scale devolatilizing extruder being used, correspond to a particular residual solvent concentration while operating the extruder at the maximum throughput rate for a given screw speed. The predicted devolatilization performance ratios for the pilot scale extruder together with the experimentally determined pilot scale devolatilization performance ratios themselves, constitute a predetermined set of devolatilization performance ratios for the pilot scale extruder. Predicted values of devolatilization performance ratio corresponding to particular solvent concentrations in the polymer product, the target characteristic of the polymer product exemplified here, are gathered in Table 6.

TABLE 6
Predicted Devolatilization Performance Ratios For The Pilot Scale
Devolatilizing Extruder Having Diameter D = 58 mm

| Target characteristic of | |
|---|---|
| the polymer product | Calculated DPR^{†} |
| 200 ppm ODCB | 2.163 |
| 150 ppm ODCB | 2.017 |
| 100 ppm ODCB | 1.871 |
| 80 ppm ODCB | 1.813 |
| 60 ppm ODCB | 1.755 |
| 40 ppm ODCB | 1.696 |
| 20 ppm ODCB | 1.638 |

^{†}Calculated DPR = (Target concentration of ODCB + 542.22)/343.22

### Examples 15 to 18 and Comparative Examples 1-6

### Experimental Corroboration of Predicted Devolatilization Performance Ratios

Examples 15 to 18 demonstrate the use of the predetermined set of devolatilization performance ratios obtained for the 25 mm laboratory extruder used in Examples 1-9. The target characteristic of the polymer product selected, 20 ppm residual ODCB, corresponds to a devolatilization performance ratio falling well outside the range of experimentally determined devolatilization performance ratios. As shown in Table 3, the predicted devolatilization performance ratio needed to achieve the target characteristic of the polymer product is 0.068 pounds of polymer-solvent mixture per hour per revolution per minute. The data for Examples 15-18 in Table 8 demonstrate that at the predicted devolatilization performance ratio of 0.068 or less the target characteristic of the polymer product (20 ppm residual ODCB) will be achieved. In this instance, the predicted devolatilization performance ratio represents a conservative estimate of the maximum throughput rate at which the target characteristic of the polymer product is achieved for a given screw speed. For example, in each of Examples 15-18 the target characteristic of the polymer product is achieved at a devolatilization performance ratio higher than 0.068. In Examples 16 and 18 the target characteristic of the polymer product is achieved even though the devolatilization performance ratio is slightly higher than 0.068 pounds per hour per revolution per minute. This experimental observation can be correlated with differences in processing conditions used in Examples 1-9 and Examples 15-18. The extruder used in Examples 15-18 comprised 6 vents with the subatmospheric vents being operated at about 2 mm Hg of absolute pressure. The extruder used in Examples 1-9 comprised 5 vents with the 2 subatmospheric vents being operated at about 10 mm Hg of absolute pressure. The enhanced devolatilization capability (one additional vent, higher vacuum) of the extruder used in Examples 15-18 permitted higher feed rates at a given screw speed and hence the target characteristic of the polymer product could be achieved at higher devolatilization performance ratio values than predicted by the data from Examples 1-9. Examples 15-18 demonstrate the importance of continuity of operation and extruder configuration in order to achieve the best possible agreement between the selected predetermined devolatilization performance ratio which correlates with the target characteristic of the polymer product and the actual result. Comparative Examples 1 and 2 (CE-1 and CE-2) demonstrate that if no vent is maintained at subatmospheric pressure the amount of residual ODCB is greater than 20 ppm. CE-3 to CE-6 demonstrate that at devolatilization performance ratios of 0.144 and higher the amount of residual ODCB is greater than 20 ppm.

TABLE 7
Experimental Conditions Used In Devolatilizaton Experiments Carried On The Laboratory Scale Devolatilizing Extruder
Having Diameter D = 25 mm Where The Target Characteristic Of The Polymer Product Is 20 ppm Residual ODCB

| | Vacuum at vents | | | | | | Solution | | | | Die |
|---|---|---|---|---|---|---|---|---|---|---|---|
| | (inches Hg) | | | | | | Mass Flow | Torque | Melt Temp. | Screw | Pressure |
| Example | V1 | V2 | V3 | V4 | V5 | V6 | Rate (lb/hr) | (%) | (° C.) | speed (rpm) | (psi) |
| 15 | Atm | Atm | Atm | 29.5 | 29.5 | 29.5 | 60 | 50 | 397 | 550 | <15 |
| 16 | Atm | Atm | Atm | 29.5 | 29.5 | closed | 60 | 50 | 398 | 550 | 41 |
| 17 | Atm | Atm | Atm | 29.5 | closed | closed | 60 | 50 | 398 | 550 | 28 |
| 18 | Atm | Atm | Atm | 29.5 | 29.5 | 29.5 | 58 | 50 | 397 | 555 | 16 |
| CE-1 | Atm | Atm | Atm | closed | closed | closed | 60 | 50 | 395 | 550 | <15 |
| CE-2 | closed | Atm | Atm | closed | closed | closed | 60 | 49 | 394 | 550 | 34 |
| CE-3 | Atm | Atm | Atm | 29.5 | 29.5 | 29.5 | 80 | 52 | 400 | 554 | <15 |
| CE-4 | Atm | Atm | Atm | 29.5 | 29.5 | 29.5 | 101 | 50 | 408 | 650 | 19 |
| CE-5 | Atm | Atm | Atm | 29.5 | 29.5 | 29.5 | 118 | 52 | 413 | 700 | <15 |
| CE-6 | Atm | Atm | Atm | 29.5 | 29.5 | 29.5 | 140 | 54 | 413 | 700 | <15 |

| | | | T feed after | T feed | | P @ | |
|---|---|---|---|---|---|---|---|
| | Actual Barrel | T feed @ | Heat | before | P @ Heat | Flash | P @ Vacuum |
| | Temperatures | Feed Tank | Exchanger | P-valve | Exchanger | valve | Manifold |
| Example | (° C.) | (° C.) | (° C.) | (° C.) | (psi) | (psi) | (mm. Hg.) |
| 15 | 350/350/348/347/358/351/ | 159 | 270 | 285 | 114 | 111 | 2.4 |
| | 344/342 | | | | | | |
| 16 | 350 × 3/351/366/349/350/ | 158 | 271 | 280 | 110 | 107 | 2 |
| | 343 | | | | | | |
| 17 | 350 × 4/361/350/351/341 | 158 | 274 | 279 | 115 | 112 | 2.1 |
| 18 | 350/351 × 2/350 × 2/349/ | 159 | 267 | 281 | 129 | 128 | 1.7 |
| | 347/337 | | | | | | |
| CE-1 | 350 × 3/349/358/349/348/ | 163 | 275 | 279 | 114 | 111 | 2 |
| | 338 | | | | | | |
| CE-2 | 352/350 × 2/349/356/350/ | 162 | 275 | 279 | 114 | 111 | 2.1 |
| | 351/343 | | | | | | |
| CE-3 | 350/351/346/347/350 × 2/ | 159 | 258 | 285 | 135 | 133 | 1.8 |
| | 349/340 | | | | | | |
| CE-4 | 350/351/349 × 2/350 × 2/ | NA | 250 | 286 | 163 | 160 | 2 |
| | 351/340 | | | | | | |
| CE-5 | 350 × 2/345/346/350/351 × 2/ | NA | 242 | 285 | 159 | 155 | 2.2 |
| | 340 | | | | | | |
| CE-6 | 350/350/342/343/349/350 × 2/ | NA | 233 | 283 | 163 | 159 | 2.45 |
| | 340 | | | | | | |

TABLE 8
Results From Devolatilizaton Experiments Carried On The Laboratory
Scale Devolatilizing Extruder Having Diameter D = 25 mm Where
The Target Characteristic Of The Polymer Product Is 20 ppm
Residual ODCB

| | Residual ODCB by | Solution YI | Devolatilization |
|---|---|---|---|
| Example | GC (ppm) | (Corrected) | performance ratio |
| 15 | <20 | 15.1 | 0.109 |
| 16 | <20 | 14.7 | 0.109 |
| 17 | <20 | 15.1 | 0.109 |
| 18 | <20 | NA | 0.105 |
| CE-1 | 632 | 15.7 | 0.109 |
| CE-2 | 1445 | 15.9 | 0.109 |
| CE-3 | 62 | NA | 0.144 |
| CE-4 | 116 | NA | 0.155 |
| CE-5 | 186 | NA | 0.169 |
| CE-6 | 407 | NA | 0.200 |

### Examples 19 to 23 and Comparative Examples 7 to 11 (Ce-7 to Ce-11)

### Isolation of a High Heat Polyetherimide Containing Reduced Levels of Low Molecular Weight Components and ODCB

The procedure used for Examples 19-23 and CE-7 to CE-11 was the same as described in the general procedure except for some variations as indicated below. The polyetherimide used for the extrusion was prepared by using the chloro displacement process. The amount of the low molecular weight components 4,4′-chlorophthalic anhydride m-phenylenediamine imide (4,4′-ClPAMI) and phthalic anhydride m-phenylenediamine imide (PAMI) in the feed polymer-solvent mixture corresponded to 219 ppm 4,4′-ClPAMI and 203 ppm PAMI. In Examples 19 and 20 and Comparative Examples CE-7, CE-8, and CE-9 the extruder barrel temperature was set to about 350° C. For Examples 21-23, CE-10 and CE-11, the extruder barrel temperature was set to about 370° C. Representative pellets obtained from this experiment were analyzed for ODCB, 4,4′-ClPAMI, and PAMI by gas chromatography (GC). Individual processing conditions used in Examples 19-23 and Comparative Examples CE-7 to CE-11 are provided in Table 9. The amount of ODCB, 4,4′-ClPAMI, and PAMI in the resultant polyetherimide pellets are provided in Table 10. Yellowness Index (YI) values for the extruded samples are provided.

TABLE 9
Experimental Conditions Used In Devolatilizaton Experiments Carried On The Laboratory
Scale Devolatilizing Extruder Having Diameter D = 25 mm Where The Target Characteristic
Of The Polymer Product Is 20 ppm Residual ODCB

| | Vacuum at vents | | | | | | Solution | | | | Die |
|---|---|---|---|---|---|---|---|---|---|---|---|
| | (inches Hg) | | | | | | Mass Flow | Torque | Melt Temp. | Screw | Pressure |
| Examples | V1 | V2 | V3 | V4 | V5 | V6 | Rate (lb/hr) | (%) | (° C.) | speed (rpm) | (psi) |
| 19 | Atm | Atm | Atm | 29.5 | 29.5 | 29.5 | 40 | 43 | 401 | 700 | 43 |
| 20 | Atm | Atm | Atm | 29.5 | 29.5 | 29.5 | 60 | 46 | 406 | 700 | 48 |
| 21 | Atm | Atm | Atm | 29.5 | 29.5 | 29.5 | 40 | 38 | 410 | 700 | 60 |
| 22 | Atm | Atm | Atm | 29.5 | 29.5 | 29.5 | 60 | 42 | 418 | 700 | 62 |
| 23 | Atm | Atm | Atm | 29.5 | 29.5 | 29.5 | 40 | 39 | 410 | 700 | 65 |
| CE-7 | Atm | Atm | Atm | 29.5 | 29.5 | 29.5 | 80 | 48 | 410 | 700 | 53 |
| CE-8 | Atm | Atm | Atm | 29.5 | 29.5 | 29.5 | 100 | 49 | 412 | 700 | 55 |
| CE-9 | Atm | Atm | Atm | 29.5 | 29.5 | 29.5 | 40 | 42 | 401 | 700 | 53 |
| CE-10 | Atm | Atm | Atm | 29.5 | 29.5 | 29.5 | 80 | 44 | 422 | 700 | 66 |
| CE-11 | Atm | Atm | Atm | 29.5 | 29.5 | 29.5 | 100 | 45 | 425 | 700 | 68 |

| | | | T feed after | T feed | | P @ | |
|---|---|---|---|---|---|---|---|
| | Actual Barrel | T feed @ | Heat | before | P @ Heat | Flash | P @ Vacuum |
| | Temperatures | Feed Tank | Exchanger | P-valve | Exchanger | valve | Manifold |
| Examples | (° C.) | (° C.) | (° C.) | (° C.) | (psi) | (psi) | (mm. Hg.) |
| 19 | 350/347/349/353/352/356/ | 152 | 281 | 286 | 130 | 127 | 0.8 |
| | 352/337 | | | | | | |
| 20 | 352/348/346/348/350/350/ | 152 | 272 | 285 | 141 | 138 | 0.9 |
| | 349/340 | | | | | | |
| 21 | 371 × 3/370 × 2/371/370/ | 160 | 282 | 280 | 123 | 121 | 16-3 |
| | 360 | | | | | | |
| 22 | 370/368/366/369/370 × 2/ | 158 | 272 | 281 | 127 | 124 | 1.5 |
| | 372/361 | | | | | | |
| 23 | 370/372/378/375/370/369/ | 160 | 281 | 287 | 123 | 120 | 15-2.3 |
| | 369/359 | | | | | | |
| CE-7 | 350 × 2/347/346/350 × 3/ | 154 | 261 | 285 | 129 | 125 | 0.9 |
| | 340 | | | | | | |
| CE-8 | 350/352/343/343/350 × 3/ | 156 | 251 | 285 | 150 | 145 | 1 |
| | 340 | | | | | | |
| CE-9 | 350/352/360/359/350 × 2/ | 152 | 281 | 286 | 120 | 118 | 1.1 |
| | 349/339 | | | | | | |
| CE-10 | 370/369/364/367/370 × 2/ | 161 | 261 | 283 | 133 | 130 | 1.3 |
| | 373/360 | | | | | | |
| CE-11 | 370/371/363/366/370 × 2/ | 159 | 251 | 284 | 144 | 139 | 1.5 |
| | 373/360 | | | | | | |

TABLE 10
Results From Devolatilizaton Experiments Carried On The
Laboratory Scale Devolatilizing Extruder Having Diameter
D = 25 mm Where The Target Characteristic Of The
Polymer Product Is 20 ppm Residual ODCB

| | Residual ODCB by GC | Solution YI | Cl-PAMI | PAMI | Devolatilization |
|---|---|---|---|---|---|
| Examples | (ppm) | (Molded) | (ppm) | (ppm) | performance ratio |
| 19 | <20 | 21.9 (99) | 117 | 138 | 0.057 |
| 20 | <20 | 20.8 (96) | 122 | 140 | 0.086 |
| 21 | <20 | 23.0 (102) | 97 | 120 | 0.057 |
| 22 | <20 | 21.8 (99) | 109 | 129 | 0.086 |
| 23 | <20 | 22.5 (101) | 76 | 94 | 0.057 |
| CE-7 | 66 | 20.9 (96) | 122 | 141 | 0.114 |
| CE-8 | 180 | 20.4 (94) | 126 | 148 | 0.143 |
| CE-9 | 22 | 21.8 (99) | 116 | 135 | 0.057 |
| CE-10 | 29 | 21.0 (96) | 108 | 128 | 0.114 |
| CE-11 | 95 | 20.7 (96) | 72 | 96 | 0.143 |

Examples 19-23 demonstrate that at devolatilization performance ratios of 0.086 or less, the polymer product will comprise less than 20 parts per millon ODCB. An added benefit is that reduced levels of low molecular weight components ClPAMI and PAMI are achieved as well. It is believed that by employing the conditions provided by the present invention the levels of low molecular weight components like 4,4′-ClPAMI and PAMI can each be reduced to less than 200 ppm based on the weight of the polymer product.

### Examples 24-29 and Comparative Examples 12-24

Examples 24 to 29 and Comparative Examples 12 to 24 (CE-12 to CE-24) illustrate the isolation of a polyetherimide from an ODCB/ULTEM® solution on a pilot scale using the JSW 58 mm twin-screw extruder. The procedure used for Examples 24-29 and CE-12 to CE-24 was the same as that used in Examples 10-14 (See also the general procedure above), except for some variations as indicated below. The extruder employed was a 58 mm diameter, co-rotating, intermeshing twin screw extruder comprising 14 barrels with L/D=54 and 9 vents for removal of volatile components. Representative pellets obtained from these experiments were analyzed for ODCB content by GC. Individual processing conditions used in Examples 24-29 and Comparative Examples CE-12 to CE-24 are provided in Table 11. The amount of ODCB in the resultant polyetherimide pellets and the molecular weight of the resultant polyetherimide are provided in Table 12. “NH” in the Table 11 refers to “not heated”.

TABLE 11
Experiments On A Pilot Scale Devolatilizing Extruder Having Diameter D = 58 mm

| | Pressure at vacuum | | | | | | | Set Barrel |
|---|---|---|---|---|---|---|---|---|
| | vents (mm of Hg) | | Solution | | Melt | Screw | Die | Temp |
| | | High | Mass Flow | Torque | Temp. | Speed | Pressure | Flash/Trace |
| Examples | Intermediate | Port/Pump | Rate (lb/hr) | (A) | (° C.) | (rpm) | (psi) | (° C.) |
| 24 | 50 | 6/11 | 515 | 119 | 359 | 325 | 273 | 371 × 4/ |
| | | | | | | | | 350 × 12 |
| 25 | 16 | 7/12 | 620 | 110 | 369 | 550 | 34 | 371/—/ |
| | | | | | | | | 371/371/371/ |
| | | | | | | | | Rest 350 |
| 26 | 56 | 7/8 | 925 | 116 | 367 | 500 | 85 | 371/—/ |
| | | | | | | | | 371/371/371/ |
| | | | | | | | | Rest 350 . . . |
| 27 | 13 | 11 | 515 | 111 | 361 | 550 | 56 | 371/—/ |
| | | | | | | | | 371/371/371/ |
| | | | | | | | | Rest 350 |
| 28 | 47 | 15.6/19.6 | 802 | 118 | 377 | 550 | 88 | 371/—/ |
| | | | | | | | | 371/371/371/ |
| | | | | | | | | Rest 350 |
| 29 | 52 | 14.5/18 | 812 | 114 | 373 | 500 | 104 | 371/—/ |
| | | | | | | | | 371/371/371/ |
| | | | | | | | | Rest 350 |
| CE-12 | 30 | 5/10 | 495 | 110 | 359 | 325 | 263 | 371 × 3/ |
| | | | | | | | | 350 × 13 |
| CE-13 | 56 | 7/11 | 1008 | 119 | 364 | 400 | 315 | 371 × 4/ |
| | | | | | | | | 350 × 12 |
| CE-14 | 55 | 7/12 | 1000 | 126 | 363 | 400 | 329 | 371 × 4/ |
| | | | | | | | | 350 × 12 |
| CE-15 | 16 | 15/17 | 605 | 122 | 354 | 300 | 114 | 371/—/ |
| | | | | | | | | 371/371/371/ |
| | | | | | | | | Rest 350 |
| CE-16 | 14 | 7/11 | 800 | 120 | 362 | 400 | 114 | 371/—/ |
| | | | | | | | | 371/371/371/ |
| | | | | | | | | Rest 350 |
| CE-17 | 14 | 6/12 | 800 | 121 | 371 | 550 | 71 | 371/—/ |
| | | | | | | | | 371/371/371/ |
| | | | | | | | | Rest 350 |
| CE-18 | 14 | 6/11 | 1000 | 120 | 373 | 550 | 76 | 371/—/ |
| | | | | | | | | 371/371/371/ |
| | | | | | | | | Rest 350 |
| CE-19 | 15 | 7/12 | 1220 | 122 | 372 | 550 | 96 | 371/—/ |
| | | | | | | | | 371/371/371/ |
| | | | | | | | | Rest 350 |
| CE-20 | 15 | 6/11 | 1330 | 128 | 373 | 550 | 108 | 371/—/ |
| | | | | | | | | 371/371/371/ |
| | | | | | | | | Rest 350 |
| CE-21 | 16 | 6/11 | 1420 | 129 | 374 | 550 | 119 | 371/—/ |
| | | | | | | | | 371/371/371/ |
| | | | | | | | | Rest 350 |
| CE-22 | 53 | 7/7 | 938 | 122 | 369 | 500 | 87 | 371/—/ |
| | | | | | | | | 371/371/371/ |
| | | | | | | | | Rest 350 . . . |
| CE-23 | 55 | 7/6 | 954 | 124 | 369 | 500 | 96 | 371/—/ |
| | | | | | | | | 371/371/371/ |
| | | | | | | | | Rest 350 . . . |
| CE-24 | 43 | 15/20 | 800 | 113 | 373 | 500 | 103 | 371/—/ |
| | | | | | | | | 371/371/371/ |
| | | | | | | | | Rest 350 |

| | Actual | | | T feed | | | Heating |
|---|---|---|---|---|---|---|---|
| | Barrel | T feed @ | T feed after | before | T | | Oil Temp. |
| | Temp. | Feed Tank | Heat Exch. | P-valve | @ Barrel 2 | P @ Flash | in ° C./(% |
| Examples | (° C.) | (° C.) | (° C.) | (° C.) | (° C.) | valve (psi) | load) |
| 24 | 324/NH/294/ | 168 | 299 | 285 | 205 | 160 | 312 |
| | 351/366/350 × 12 | | | | | | |
| 25 | 331/—/ | 177 | 314 | 316 | 244 | 161 | 327/(68) |
| | 339/391/375/ | | | | | | |
| | Rest 350 | | | | | | |
| 26 | 337/—/ | 180 | 301 | 302 | 225 | 161 | 316/(68) |
| | 310/359/369/ | | | | | | |
| | 350/Rest | | | | | | |
| | 350 | | | | | | |
| 27 | 318/—/ | 181 | 288 | 283 | 214 | 178 | — |
| | 335/370/371/ | | | | | | |
| | Rest 350 | | | | | | |
| 28 | 371/—/ | 173 | 310 | 310 | 239 | 180 | —/(75) |
| | 332/368/371/ | | | | | | |
| | Rest 350 | | | | | | |
| 29 | 316/—/ | 161 | 306 | 302 | 218 | 184 | —/(81) |
| | 311/363/370/ | | | | | | |
| | Rest 350 | | | | | | |
| CE-12 | 333/NH/324/ | 180 | 302 | 296 | 219 | 175 | 316 |
| | 372/350 × 13 | | | | | | |
| CE-13 | 321/NH/303/ | 178 | 294 | 291 | 216 | 167 | 313-309 |
| | 343/363/350 × 12 | | | | | | |
| CE-14 | 318/NH/287/ | 175 | 292 | 284 | 205 | 170 | 310 |
| | 334/356/350 × 12 | | | | | | |
| CE-15 | 316/—/ | 182 | 314 | 316 | 224 | 163 | 327/(72) |
| | 321/368/378/ | | | | | | |
| | Rest 350 | | | | | | |
| CE-16 | 319/—/ | 181 | 314 | 315 | 226 | 163 | 327/(72) |
| | 316/364/369/ | | | | | | |
| | Rest 350 | | | | | | |
| CE-17 | 338/—/ | 176 | 314 | 316 | 246 | 164 | 327/(72) |
| | 343368/369/ | | | | | | |
| | Rest 350 | | | | | | |
| CE-18 | 338/—/ | 176 | 313 | 315 | 237 | 168 | 327/(76) |
| | 326/361/369/ | | | | | | |
| | Rest 350 | | | | | | |
| CE-19 | 336/—/ | 174 | 309 | 314 | 230 | 168 | 327/(84) |
| | 310/353/364/ | | | | | | |
| | Rest 350 | | | | | | |
| CE-20 | 339/—/ | 175 | 308 | 312 | 228 | 168 | 327/(84) |
| | 305/347/363/ | | | | | | |
| | Rest 350 | | | | | | |
| CE-21 | 343/—/ | 174 | 307 | 312 | 226 | 175 | 327/(85) |
| | 300/344/369/ | | | | | | |
| | Rest 350 | | | | | | |
| CE-22 | 342/—/ | 180 | 299 | 303 | 223 | 168 | 316/(66) |
| | 302/361/371/ | | | | | | |
| | 350/Rest | | | | | | |
| | 350 | | | | | | |
| CE-23 | 352/—/ | 179 | 299 | 299 | 222 | 167 | 316/(70) |
| | 299/352/371/ | | | | | | |
| | 350/Rest | | | | | | |
| | 350 | | | | | | |
| CE-24 | 348/—/ | 174 | 313 | 310 | 235 | 175 | —/(73) |
| | 327/374/372/ | | | | | | |
| | Rest 350 | | | | | | |

TABLE 12
Results From Experiments On A Pilot Scale Extruder Having Diameter
D = 58 mm

| | | % Solids in | | |
|---|---|---|---|---|
| | Residual | POLYMER- | | Devolatilization |
| Exam- | o-DCB | SOLVENT | Molecular weight | performance |
| ple | (ppm) | MIXTURE | Mw/Mn/PI | ratio |
| 24 | <20 | 30-32% | 49794/20533/2.42 | 1.585 |
| 25 | <20 | 27% | 47200 | 1.127 |
| 26 | <20 | 27% | 46700/21300/2.19 | 1.850 |
| 27 | <20 | — | 46800/20300/2.30 | 0.936 |
| 28 | <20 | — | 50600/18900/2.68 | 1.458 |
| 29 | <20 | — | 49800/18600/2.68 | 1.624 |
| CE-12 | 84 | 30-32% | 48817/20091/2.43 | 1.523 |
| CE-13 | 319 | 30-32% | 48874/20242/2.41 | 2.520 |
| CE-14 | 310 | 30-32% | 49734/20584/2.42 | 2.500 |
| CE-15 | 200 | 27% | 46100 | 2.017 |
| CE-16 | 100 | 27% | 45800 | 2.000 |
| CE-17 | 52 | 27% | 46700 | 1.455 |
| CE-18 | 85 | 27% | 46400 | 1.818 |
| CE-19 | 142 | 27% | 46000 | 2.218 |
| CE-20 | 202 | 27% | 47300/19800/2.39 | 2.418 |
| CE-21 | 283 | 27% | 47400/19900/2.38 | 2.582 |
| CE-22 | 50 | 27% | 46700/21500/2.18 | 1.876 |
| CE-23 | 70 | 27% | 46800/21500/2.18 | 1.908 |
| CE-24 | 580 | — | 50200/18900/2.66 | 1.600 |

Examples 24-29 demonstrate embodiments of the invention wherein at a devolatilization performance ratio of less than about 1.638 (See Table 6) the amount of residual ODCB in the product polymer is less than 20 ppm on the 58 mm extruder. For reasons not fully understood, several of the Comparative Examples (CE-12, CE-17 and CE-24) showed levels of residual ODCB higher than 20 ppm despite the fact that the devolatilization performance ratio was less than about 1.638. Departures from the predictive model as seen in Comparative Examples 12, 17 and 24 are thought to be the result of variable behavior of the test equipment and are not believed to detract from the predictive model itself. Thus, in CE-12 the extruder may not have reached steady state before the sample was withdrawn since the sample was taken immediately after start-up. There may have been variations in extruder barrel temperature and oil heater temperature during the experiment. Again in CE-17 the higher value of residual ODCB may be attributed to a number of factors such as for example discrepancy between vent and/or pump pressure values, polyetherimide getting contaminated with degraded material from previous isolation runs or variation in solid concentration of polymer in the polymer-solvent mixture. In CE-24 the first sample was withdrawn before the system stabilized. Also the experiment was started with all vents connected to atmospheric pressure and there was some discrepancy between the pressure read by the pressure transducer in the high vacuum zone of the extruder and that read by the vacuum system. It is noted as well that the polyetherimide used in CE-24 was the highest molecular weight material studied and this may have influenced the outcome.

The above experiments indicate that by and large by employing the processing conditions provided by the present invention the level of residual solvent may be reduced to less than 20 ppm. Those skilled in the art will appreciate that the pilot scale experiments by their very nature will tend to exhibit increased variability relative to laboratory experiments. The variations in results observed here may be attributed to various factors including: (i) error in measuring residuals, (ii) extruder design (screw, vents, etc.) used to produce these data may have differed in some runs, (iii) the solution may have had different solids concentration than the assumed 30 or 33 percent (sometimes the solution was diluted to take it out of the reactor, and later concentrated again), (iv) samples were in some instances taken at the beginning of an experiment before the extruder system achieved steady state, or at the end of the experiment where the feed solution may have nearly depleted and as a result the extruder may have been under filled, or the atmosphere to vacuum seal broken, etc., (v) fluctuations or uncertainties in vacuum pressure i.e., discrepancy between vent and pump pressure values, and (vi) resin variability i.e., in some experiments, pellets from previous isolation runs were used, and they may have been slightly degraded and/or contaminated. Differences between the experiments used to generate the predetermined set of devolatilization performance ratios gathered in Table 6, and the actual experimental results obtained in Examples 24-29 and CE12-CE24 (See Table 12) were the concentration of polymer in the polymer-solvent mixture (33.1% versus 27% or 30-32%), the number of vents 8 versus 9), slight differences in screw design, and the molecular weights of the polyetherimide resins used to prepare the polymer-solvent mixtures.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of separating a polymer from a solvent, said method comprising:
introducing a superheated polymer-solvent mixture into an extruder, and isolating a polymer product, said extruder being equipped with at least one vent operated at subatmospheric pressure and at least one vent operated at about atmospheric pressure, said extruder having a screw diameter D, said extruder being operated at a feed rate FR and at a screw speed RPM such that a devolatilization performance ratio (DPR) given by Equation (I)
DPR=FR/RPM Equation (I)
is selected from a predetermined set of devolatilization performance ratios which correlate with a target characteristic of the polymer product.

2. The method according to claim 1, wherein the characteristic of the polymer product is a concentration of residual solvent.

3. The method according to claim 1, wherein the characteristic of the polymer product is a concentration of residual monomer.

4. The method according to claim 1, wherein the characteristic of the polymer product is a molecular weight.

5. The method according to claim 1, wherein the polymer product is selected from the group consisting of polyetherimides, polyethersulfones, polycarbonates, and mixtures of two or more of the foregoing polymers.

6. The method according to claim 1, wherein the polymer product is a polyetherimide, the characteristic of the polymer product is a concentration of residual orthodichlorobenzene solvent, D is from about 10 to 30 millimeters.

7. The method according to claim 1, wherein the polymer product is a polyetherimide, the characteristic of the polymer product is a concentration of residual orthodichlorobenzene solvent, D is in a range from about 30 millimeters to about 60 millimeters.

8. The method according to claim 1, wherein the polymer product is a polyetherimide, the characteristic of the polymer product is a concentration of residual orthodichlorobenzene solvent, D is in a range from about 60 millimeters to about 140 millimeters.

9. The method according to claim 1, wherein the polymer product is a polyetherimide, the characteristic of the polymer product is a concentration of residual orthodichlorobenzene solvent, D is from about 140 millimeters to about 380 millimeters.

10. The method according to claim 1, wherein the superheated polymer-solvent mixture has a temperature of about 2° C. to about 200° C. higher than the boiling point of the solvent at atmospheric pressure.

11. The method according to claim 1, wherein the polymer-solvent mixture comprises less than or equal to about 35 percent by weight polymer based on a total weight of the polymer and the solvent.

12. The method according to claim 1, wherein the extruder further comprises at least one side feeder wherein the side feeder comprises a vent operated at about 400 millimeter of mercury of absolute pressure or greater.

13. The method according to claim 1, wherein the extruder is a twin-screw counter-rotating extruder, a twin-screw co-rotating extruder, a single-screw extruder, or a single-screw reciprocating extruder.

14. The method according to claim 1, wherein the extruder is a twin-screw, co-rotating intermeshing extruder.

15. The method according to claim 1, wherein the solvent is a halogenated aromatic solvent, a halogenated aliphatic solvent, a non-halogenated aromatic solvent, a non-halogenated aliphatic solvent, or a mixture containing at least two of the foregoing solvents.

16. A method of separating a polyetherimide from a solvent, said method comprising:
introducing a superheated polymer-solvent mixture comprising a polyetherimide and a solvent into an extruder, and isolating a polyetherimide product, said solvent comprising at least 25 percent by weight of the polymer-solvent mixture, said extruder being equipped with at least one vent operated at subatmospheric pressure and at least one vent operated at about atmospheric pressure, said extruder having a screw diameter D, said extruder being operated at a feed rate FR and at a screw speed RPM such that a devolatilization performance ratio (DPR) given by Equation (I)
DPR=FR/RPM Equation (I)
is selected from a predetermined set of devolatilization performance ratios which correlate with a characteristic of the polyetherimide product, wherein said characteristic of the polyetherimide product is a concentration of solvent of less than 20 parts per million.

17. The method according to claim 16, wherein said polyetherimide product comprises less than 200 parts per million residual monomer.

18. The method according to claim 16, wherein said product polyetherimide has a number average molecular weight of at least 10,000 grams per mole.

19. A method of separating a polymer from a solvent, said method comprising:
introducing a superheated polymer-solvent mixture into an extruder, and isolating a polymer product, said extruder being equipped with at least one vent operated at subatmospheric pressure and at least one vent operated at about atmospheric pressure, said extruder having a screw diameter D in a range from about 130 to about 380 millimeters, said extruder being operated at a feed rate FR and at a screw speed RPM such that a devolatilization performance ratio (DPR) given by Equation (I)
DPR=FR/RPM Equation (I)
is selected from a predetermined set of devolatilization performance ratios which correlate with a characteristic of the polymer product.

20. The method according to claim 1, wherein said polymer product is a polyetherimide having a number average molecular weight of at least 10,000 grams per mole.
